(19) United States
(12) Patent Application Publication
(10) Pub. No.: US 2026/0056543 A1
(43) Pub. Date: Feb. 26, 2026

(54) REMOTE DRIVING CONTROL OF VEHICLES ON GENERIC WORKPLACES

(71) Applicant: Deutsche Telekom AG, Bonn (DE)

(72) Inventors: André ANGIERSKI, Berlin (DE); Pragya AGARWAL, Aachen (DE)

(21) Appl. No.: 19/102,862

(22) PCT Filed: Aug. 9, 2023
(86) PCT No.: PCT/EP2023/072027

§ 371 Date: Feb. 11, 2025

(30) Foreign Application Priority Data
Aug. 12, 2022 (EP) 22190188.7

(51) Int. Cl. G05D 1/224; A01B 76/00; B61L 27/30; B63B 79/40; G05D 101/00

(52) U.S. Cl. CPC G05D 1/2242; A01B 76/00; B61L 27/30; B63B 79/40; G05D 2101/22

(57) ABSTRACT

A method for enabling remote driving control of railway vehicles, ship vehicles, drones, and/or farm vehicles via a generic workspace includes: using, by a remote driving control system, a driving-control-converting-algorithm, wherein the driving-control-converting-algorithm transforms control elements and/or status elements of a vehicle into a vehicle-specific model; providing, by the remote driving control system, the vehicle-specific model with data received from a vehicle operation onboard unit and/or a remote control onboard unit of the vehicle as input data, wherein the vehicle-specific model is configured to recognize the data and pass it to respective abstracted control elements and/or status elements which results in a real-time-vehicle-specific model; and displaying, by the remote driving control system, the real-time-vehicle-specific model on a remote operator workspace, wherein the vehicle is driven based on a remote operator interacting with the real-time-vehicle-specific model via operating element(s) of the remote operator workspace.

### CROSS-REFERENCE TO PRIOR APPLICATIONS

This application is a U.S. National Phase application under 35 U.S.C. § 371 of International Application No. PCT/EP2023/072027, filed on Aug. 9, 2023, and claims benefit to European Patent Application No. EP 22190188.7, filed on Aug. 12, 2022. The International Application was published in English on Feb. 15, 2024 as WO 2024/033406 A1 under PCT Article 21(2).

### FIELD

The invention relates to a method, a remote driving control system and a computer program to enable a remote driving control of railway vehicles, ship vehicles, drones, and/or farm vehicles on a generic workplace.

### BACKGROUND

It is possible to perform remote operations of railway vehicles. A remote controlled train is a railway locomotive that can be operated with a remote control. It differs from a conventional locomotive in that a remote control system has been installed in the locomotive, which uses a radio transceiver system to communicate with remote operators. The locomotive is operated by a person not physically present at the driving controls within the confines of the locomotive cab. They have been in use for many years in the railroad industry, including industrial applications such as bulk material load-out, manufacturing, process and industrial switching.

To facilitate such a remote control of the train, the remote control system comprises at least a remote control onboard unit that provides an interface to the train. The remote control can be part of an automatic train operation onboard unit or standalone unit. The automatic train operation onboard unit comprises a self-driving functionality. However, there are traffic situations in which those self-driving capacities are not sufficient and the remote control is used to facilitate the driving of the vehicle by a remote-driver.

The automatic train operation onboard unit and/or the remote control onboard unit captures video data or receives video data via a camera of the train, wherein this video data basically shows the same field of view that the train's driver would normally see from inside the locomotive cab. This video data can be assessed by single or multiple cameras, sensor images (radar, lidar, . . . ) and can be preprocessed, e.g. for obstacle detection or highlighting.

The automatic train operation and/or the remote control onboard unit also captures or receives diagnostic and/or status train information and from other onboard systems.

The automatic train operation and/or the remote control onboard unit comprises a communication interface, in particular a radio transceiver, that is configured to send the video data and the diagnostic and/or status train information to a remote operator desk and to receive operational commands from the remote operator desk. The remote operator desk, which is also part of the remote control system, comprises an interface to receive the data sent by the automatic train operation and/or the remote control onboard unit and to send operational commands to the automatic train operation and/or to the remote control onboard unit, respectively the train.

The remote operator desk is configured to present the video data and/or the diagnostic and/or the status information of the train on a display so that a remote driver can steer the train as if he would be in the train's cab. Hence, the basic design for remote operator desk in railways uses a 1-to-1 relation between the vehicle and the remote operator desk. In other word, the remote operator desk mimics the actual control device in a 1-to-1 relation.

The remote operator desk includes every control knob, lever, indicator, etc. As a result, the workplace needs to be designed for one specific vehicle (type) and cannot be reused for remote operations of other railway vehicles.

### SUMMARY

In an exemplary embodiment, the present invention provides a method for enabling remote driving control of railway vehicles, ship vehicles, drones, and/or farm vehicles via a generic workspace. The method includes: using, by a remote driving control system, a driving-control-converting-algorithm, wherein the driving-control-converting-algorithm transforms control elements and/or status elements of a vehicle into a vehicle-specific model; providing, by the remote driving control system, the vehicle-specific model with data received from a vehicle operation onboard unit and/or a remote control onboard unit of the vehicle as input data, wherein the vehicle-specific model is configured to recognize the data and pass it to respective abstracted control elements and/or status elements which results in a real-time-vehicle-specific model; and displaying, by the remote driving control system, the real-time-vehicle-specific model on a remote operator workspace, wherein the vehicle is driven based on a remote operator interacting with the real-time-vehicle-specific model via operating element(s) of the remote operator workspace.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b show a remote driving control system according to the invention. FIG. 1b is a continuation of FIG. 1a.

### DETAILED DESCRIPTION

Exemplary embodiments of the present invention provide techniques to enable a highly flexible solution for remote control of railway vehicles (such as trains), ships, drones, and/or farm vehicles (such as tractors).

The railway vehicles, ships, drones, and/or farm vehicles have the characteristic feature in common that they can be operated in “low traffic” situations in which the remote operation of such vehicles is not as time critical as it is with cars. For example, the trains travel on railways, wherein the railways guide the trains along their way and they typically do not interact frequently with other trains, so that they are especially suited for remote control operation. If ships travel over the ocean, there is also only minor traffic so that they can also be steered by remote control operation. However, this can change if the ship enters a harbor region. Nevertheless, it is possible that a real person enters the ship and takes over the control if the ship enters such a harbor region. Typically, farm vehicles are alone on the field and can greatly be controlled by remote operation.

The features of the various aspects of the invention described below or the various examples of implementation may be combined with each other, unless this is explicitly excluded or is technically impossible.

According to a first aspect of the invention, a method is provided to enable a remote driving control of railway vehicles, ship vehicles, drones, and/or farm vehicles on a generic workplace, the method comprises the following steps:
Providing a driving-control-converting-algorithm, wherein the driving-control-converting-algorithm transforms control elements and/or status elements of a specific vehicle into a vehicle-specific-2D-model, a vehicle-specific-model or a virtual-reality-model;
   If the vehicle-specific-model can be displayed on a 2D screen it can be named vehicle-specific-2D-model;
   control elements of the vehicle can be engine control, traction units, braking units, steering units, signaling elements and/or other units that “have an effect” on the behavior of the vehicle. The status elements are basically those parts of the vehicle that the driver of the vehicle observes while driving the vehicle. The status elements can also include diagnostic parts of the vehicle. In that sense the status elements describe the condition or functionality of the vehicle, like air pressure, temperature, condition of brakes, and/or speed indicator etc. Another embodiment of a status element, is a representation of the view side of the direction of travel a driver can see as if they were inside the cab. In the context of this invention transforming those elements means that the physical functionality, for example the brake force of multiple braking units, is converted to the models described above. For example, the brake force can be represented by a bar representation that is filled with color depending on the status of the brake force. For example, if this 2D representation is not filled at all, this corresponds to the case that the vehicle is not exerting any brake force at all, wherein a 2D bar representation totally filled with color corresponds to the case that the vehicle is exerting maximum brake force; another way to describe this transformation is to say that the physical functionalities are translated to a graphical representation, whereas the remote driver can interact with the graphical representation to remotely drive the vehicle;
   when performing the appropriate abstraction or transformation, it is nevertheless important to have in mind that those vehicles are generally very different from each other, i.e. that they comprise different control elements and/or status elements and behave differently when being driven by a remote operator; therefore, the driving-control-converting-algorithm is configured to take the properties of the individual vehicles into account. The vehicle-specific-model or the virtual-reality-model can be generated by the driving-control-converting-algorithm and stored within a database in order to decrease the computational overhead. In this sense, the vehicle-specific-model or the virtual-reality-model can be described as offline models;
   the driving-control-converting-algorithm, the vehicle-specific-model and/or the real-time-vehicle-specific-model can be implemented on a server, wherein the server can send driving commands of an operator to the vehicle, wherein the real-time-vehicle-specific-model or another dedicated algorithm generates driving commands due to this interaction of the operator;
Providing the vehicle-specific-model with data received from an automatic train operation onboard unit and/or a remote control onboard unit of that vehicle as input data, wherein the vehicle-specific-model is configured to recognize the data and pass it to the appropriate transformed control elements and/or status elements which results in a real-time-vehicle-specific-model;
   the data received indicates the status, the values of the control elements and/or status elements and feeds the current information of the vehicle into the vehicle-specific-model or the virtual-reality-model. For example, the data received can be i) video data, in particular in an embodiment of a video stream, that shows the surroundings, in particular in the traveling direction of the vehicle, ii) the actual values of the vehicle like air pressure, the temperature, the condition of brakes, and/or the speed indicator etc. In this sense, one could say that the offline model is filled with “life”. It provides a representation of the real vehicle with an accuracy that suffices to operate the train remotely.
   to put the data received into the correct control and/or status elements, the algorithm of the vehicle-specific-model can determine the kind of data, for example based on a defined protocol. For example, the video data shows a different data type than the speed information so that the data can be written into the corresponding control and/or status element.
   it follows that the automatic train operation onboard unit and/or the remote control onboard unit is configured to receive and transmit the corresponding data set. It is beneficial if the automatic train operation onboard unit and/or the remote control onboard unit comprises a mobile communication interface that is configured to provide 3G, 4G, 5G or further standards. In particular, in the case of ships, the communication interface can be configured to provide satellite-based mobile communication;
   in that sense the status elements can be video data, in particular in an embodiment of a video stream, that shows the surroundings, in particular in the traveling direction, of the vehicle or information about the functionality (oil pressure, etc.) of the units of the vehicle;
Displaying the real-time-vehicle-specific-model on a remote operator workspace, wherein a remote operator drives the vehicle by interacting with the real-time-vehicle-specific-model via operating interface(s) of the workspace.
   by interacting with the real-time-vehicle-specific-model, the real-time-vehicle-specific-model is configured to generate driving commands based on this interaction by the remote operator. For example, possible interactions are to increase the traction forces of the vehicle for acceleration, to make braking maneuvers for deceleration, and/or to change the direction of the vehicle etc. The remote operator workspace is also configured to send those commands over a communication network back to the vehicle. For that purpose, it can use the same communication standards as the automatic train operation onboard unit and/or the remote control onboard unit. The commands are received by the automatic train operation onboard unit and/or the remote control onboard unit, wherein the automatic train operation onboard unit and/or the remote control onboard unit controls the vehicle according to those commands.
   The invention provides the advantage that it decouples vehicle characteristics as much as possible from the characteristics of a remote operator workspace and breaks the common 1-1 representation of the workspace. It provides an abstraction of real characteristics to the vehicle-specific-model. Hence, a kind of generic workspace is enabled that allows to remotely operate a wide range of different vehicles. The representation on this flexible workspace can be designed to be more uniform so that is easier for remote operators to adapt to another vehicle type. Another advantage is that a common computer can be used to remotely operate the vehicle so that is even possible to provide this remote driving as a cloud service. The transformation according to the vehicle-specific-model according to the invention is the abstraction of physical functionalities of the vehicle to a (graphical) representation, whereas the remote driver can interact with the (graphical) representation to remotely drive the vehicle; as specific vehicles all undergo this abstraction step into the vehicle-specific-model, it gets possible to operate the vehicle on the generic workplace.

In an embodiment, the driving-control-converting-algorithm has access to and uses a database that stores default configuration data and/or real-time configuration data of the specific vehicle.

This provides the advantage that the driving-control-converting-algorithm can generate a model that takes the differences of the different vehicles into account. The default configuration data can be construction plan data that shows which “value” a control elements and/or status element of a certain vehicle actually should have and how these elements are configured according to the plan. However, according to real life, an actual vehicle generally differs from the vehicle as planned so that the real-time-vehicle-specific-model becomes even more accurate if real-time configuration data is taken into account. Hence, real-time configuration data can comprise calibration data (of braking units, traction units, etc.). The real-time configuration data can be data captured from the vehicle and/or its onboard unit(s) itself, but it can also be data captured from the track or from further vehicles that indicates emergency situations and are the statues of the track, e.g. directly through onboard diagnostics (e.g. failures from onboard units) or indirect through data analytics on trackside/cloud. For example, it can be measured that a railroad is due to certain weather conditions more slippery than expected. Via the real-time configuration data, the real-time-vehicle-specific-model can be adjusted accordingly to consider a longer braking distance, for example.

In an embodiment, the real-time configuration data comprises sensor data of the vehicle, of another vehicle, of track sensors and/or of timetables.

As already described above, the real-time configuration data can be used to adapt the real-time-vehicle-specific-model to the current situation of the vehicle. In that sense, the real-time configuration data can change in the database that is used by the driving-control-converting-algorithm. Another example is that weight sensors of the vehicle can determine the mass of the vehicle that has an impact on acceleration, on braking and/or on steerability of the vehicle. It is also possible to use timetables to predict the mass of the vehicle. For example, according to the timetable it can be expected that there is a higher mass during rush hours.

In an embodiment, at least two real-time-vehicle-specific-models are displayed on a screen or on a virtual glasses of the workspace. In particular, this can be used for supervision tasks.

This provides the advantage that the remote operator supervises more than one vehicle at once and takes over the driving for one of this vehicles at different times. It is also possible that the remote operator drives vehicles of a different kind by using the same workplace. The highly simplified presentation of the vehicles makes it even possible that the remote operator might be able to drive trains as well as ships. In particular, this is possible if the vehicles travel through low traffic areas in which it is not necessary to perform very frequent driving commands. This can be the case if a ship travels over the ocean or if the train travels in a sparsely populated landscape. When the ship or the train approaches a last mile region it might be beneficial if the other vehicles of the remote workspace are stopped or if the control for the last mile region is handed over to another remote operator who then only drives for the specific vehicle and can fully concentrate on a high-traffic situation of the last mile.

In an embodiment, the real-time-vehicle-specific-model that corresponds to the vehicle the operator is currently driving is displayed in a highlighted mode.

The highlighted mode provides the advantage that the operator is actually aware of which vehicle he is currently driving so that the risk that he mixes up the different vehicles is reduced.

In an embodiment, the highlighted mode shows the current real-time-vehicle-specific-model in bigger size and/or with a higher data rate than the other non-current real-time-vehicle-specific-models.

The current real-time-vehicle-specific-model can be displayed in a big size view in the middle of the screen, whereas the real-time-vehicle-specific-models of the other vehicles can be arranged on the side of the screen in smaller size. If this current real-time-vehicle-specific-model is provided with a higher data rate, in particular with a higher data rate of the video stream that shows the driving view of the vehicle, it is possible to efficiently reduce the overall data volume of the method. It is even possible that the operator defines the data rate and/or the resolution of each of the real-time-vehicle-specific-models dynamically.

Especially, in low traffic areas, a data rate of one image per second, in particular one image per 5 seconds, can be sufficient to remotely operate the vehicle, wherein the data rate can depend on the vehicle. The value of the requested data rate of each real-time-vehicle-specific-model is sent to the vehicle so that it can adapt its sending characteristics accordingly.

In an embodiment, a pop-up window with vehicle specific information appears when the operator switches between different real-time-vehicle-specific-models and/or that pop-up window with emergency information appears if an emergency is detected by the vehicle, by track sensors, or other source of information. The information can also comprise a tutorial or interactive quick start guide. Control can only be taken over afterwards acknowledgement of this information.

This provides the advantage that the remote operator is aware of important differences of the vehicles and/or he is informed of emergency situations of a certain vehicle while he is currently driving another vehicle. An emergency situation can be assessed if the vehicle operates outside defined parameters or if a possible obstacle is detected in the video stream.

In an embodiment, an illustration of the vehicle is displayed in a virtual environment and/or within captured video data of the vehicle, wherein this illustration also shows steering angle and braking predictions as lines, wherein the predictions are based on the usage of the operating interface(s) by the operator and the real-time-vehicle-specific-model.

This provides the advantage that the operator actually sees how the vehicle behaves due to his steering in a kind of representation that mimics the reality. The illustration can be a kind of icon that shows the vehicle and can be configured to mimic the view as if the operator would sit in the cabin. The steering angel and braking prediction lines help the operator to see how the vehicle would behave based on the current driving commands. This is especially beneficial for the invention because the operator is able to drive a great variety of different vehicles that all behave differently. For example, a fully loaded cargo train will have longer braking distance than an empty passenger train. The prediction lines show where the respective vehicle is expected to stop so that the operator can increase the braking force if there is a need to stop earlier. The purpose is to compensate for missing “feelings” of the remote operator like vibrations, G-forces etc.

In an embodiment, the operating interface(s) comprise a computer mouse, a touchscreen, a keyboard, and/or a joystick. It is also possible to partly re-build a driver cab as a steering wheel can be used by many vehicles.

This provides the advantage that the operator can interact with the real-time-vehicle-specific-model displayed on a generic workspace. By using a combination of operating interfaces, it is possible to generate complex commands that should be able to account for almost all if not for any driving situation. In particular, known joysticks of manufacturers of gaming consoles are configured to enable driving of the ships, trains, drones and/or farm vehicles as different simulator games of the vehicles already exist.

In an embodiment, a graphical illustration of the specific upcoming route information is provided to support the remote operator with his driving task.

In an embodiment, the joystick comprises force feedback elements, wherein the force feedback is adjusted according to the vehicle that is currently under operation. The joystick can be loaded with configuration data that corresponds to the vehicle that is currently under operation.

This provides the advantage that the operator actually gets the feeling that one vehicle is different than another vehicle. For example, if the train is heavier than the braking and/or the acceleration resistance can be increased. Hence, the operator gets the feeling that he has to brake harder in order to stop the heavier vehicle.

In an embodiment, the driver receives feedback on specific information from the vehicle under control through vibration machines and LEDs, loudspeakers installed on chairs and workplaces for the remote operator.

In an embodiment, devices like vibration machines, LEDs and loudspeakers can be provided also as smart devices or wearables.

In an embodiment, the driver attention can be increased for certain situations by using a vibration machine or LEDs. For example, if a train slips and/or slides or on a different vehicle turbulences occur, the vibration machine can feed this information directly to the remote operator.

In an embodiment, the driver's attention can be supervised via
classical buttons operated by hands or feet in a cyclic manner;
computer vision system and image/video analysis that analyses the remote operator's activity, e.g. eyes, hands, head or distraction through smartphones, colleagues, and others;
biological sensors, e.g. heart rate monitoring.

In case the driver vigilance device detects the remote operator's attention is not given or not sufficient an alarm can be given to the remote operator and thereafter the vehicle operation can transition either into a safe state, e.g. land vehicles brake automatically, or remote control can be handed over to a different remote operator.

In an embodiment, the attention of the remote operator is supervised during operations through a driver vigilance device.

In an embodiment, the driver vigilance device is realized via finger or hand or foot activated buttons and/or eye and/or head tracking and/or by tracking of hand activities and/or via distraction and/or via biological sensor information.

In an embodiment, the remote operator workspace comprises virtual glasses, a desktop PC, a smartphone, and/or a tablet.

This provides the advantage that the invention can be used in a very flexible way on many generic systems, even on a mobile communication device. It is even possible that the display of the real-time-vehicle-specific-model can be adapted to the actual remote operator backspace in use. For example, due to the smaller display of the smart phone it might be only allowed to remotely drive one vehicle at once or the allowance can be restricted to supervision and emergency stop.

In an embodiment, an appearance of the real-time-vehicle-specific-model can be adjusted by the operator, and/or takes the characteristics of the workspace into account.

This provides the advantage that the operator can adjust the representation to his individual needs as to increase his performance.

In an embodiment, the driving-control converting algorithm, the database and/or the real-time-vehicle-specific-model are implemented on a cloud server or central data center.

This provides the advantage that the remote driving operation can be provided as a cloud service or alike. If the driving-control converting algorithm is implemented on a central server, it can be updated more easily and computational power can be easier scaled up. The same is true for the database. If the real-time-vehicle-specific-model is run on the central server within the cloud, the remote control of the different vehicles can be distributed amongst multiple remote operators in a very flexible way. For example, an operator can pass the remote driving of a vehicle easily to another operator, wherein the cloud server simply establishes the communication with that vehicle with another operator. Furthermore, the remote driving is not restricted to defined locations but is even possible in home office environments dependent on the availability of certain interfaces, e.g. joysticks.

According to a second aspect, the invention provides a remote driving control system to enable a remote driving control of railway vehicles, ship vehicles, drones, and/or farm vehicles on a generic workplace, comprising
a server having
   a communication interface to a vehicle, wherein the communication interface is configured to receive data captured by the vehicle, in particular by an automatic train operation onboard unit and/or a remote control onboard unit, and to send driving commands of an operator to the vehicle;
   a computing unit configured
      to use a driving-control-converting-algorithm that is implemented on the computing unit to abstract control elements of a specific vehicle into a vehicle-specific-model or a virtual-reality-model;
      to provide the vehicle-specific-model with data received from the automatic train operation onboard unit and/or the remote control onboard unit of that vehicle as input data, wherein the vehicle-specific-model is configured to recognize the data and pass it to the appropriate abstracted control elements and/or status elements and to generate in a real-time-vehicle-specific-model;
a display for displaying the real-time-vehicle-specific-model to the remote operator;
operating interface(s) configured to enable an interaction of the remote operator with the real-time-vehicle-specific-model, wherein the real-time-vehicle-specific-model or another dedicated algorithm generates driving commands due to this interaction.

The remote driving control system basically provides the same advantages as described in context with the method above. In particular, it is possible that the server is located as a central cloud server within a cloud environment or as a central data center. The remote driving control system can also comprise the remote workspace and/or the vehicle that is remotely operated itself. Furthermore, the remote driving control system can comprise the communication network that enables the data connection between the server, the vehicle, the operating interface(s) and/or the remote workspace.

The remote driving control system can be configured to carry out the method described above.

According to a third aspect of the invention, a computer program comprises instructions which, when the program is executed by a computing unit, in particular a server, cause the computing unit to carry out the steps of
Generating a transformed vehicle-specific-model or a virtual-reality-model of a vehicle according to the method described above.

This enables the advantage that is possible to generate the transformed or abstracted vehicle-specific-model or a virtual-reality-model that can be used to operate the vehicle on generic workspace.

It is also possible that the computer program comprises instructions to generate a real-time-vehicle-specific-model as described above based on data received from the automatic train operation onboard unit and/or the remote control onboard unit as input data.

It is also possible that the computer program comprises instructions to generate driving commands due to the interaction of a remote operator with the real-time-vehicle-specific-model.

In the following, numerous features of the present invention are explained in detail via preferred embodiments. The present disclosure is not limited to the specifically named combinations of features. Rather, the features mentioned here can be combined into other inventive embodiments, unless this is expressly excluded below.

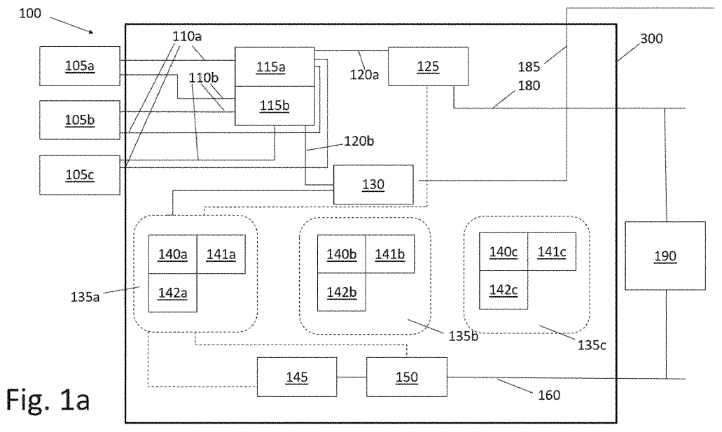

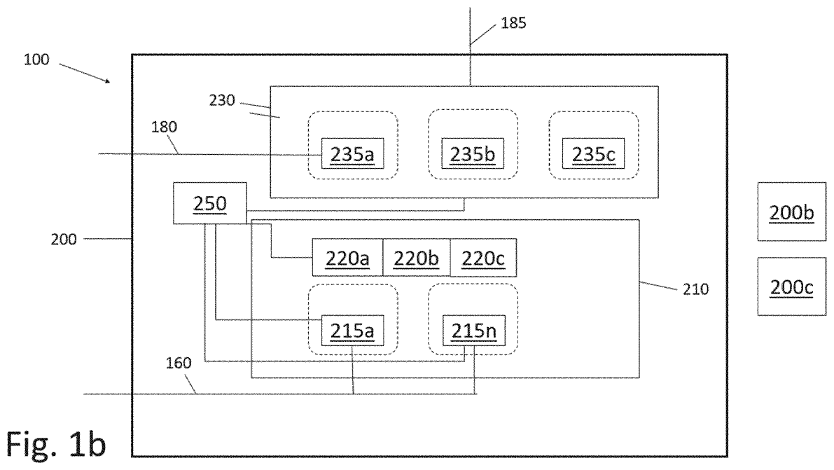

FIGS. 1a-1b show a remote driving control system 100 according to the invention, wherein FIG. 1b is a continuation of FIGS. 1a because it was not practical to show the overall remote driving control system on one page. FIGS. 1a-1b show in an exemplary embodiment three different onboard units 105a-c of three different trains. In the following, the term onboard unit will be used as an abbreviation for an automatic train operation onboard unit and/or a remote control onboard unit that is described above.

The train with the onboard unit 105a is considered to be the train that is currently remotely driven by an operator. The onboard unit 105a transmits video data via a communication link 110a to a video data interface 115a of the cloud environment 300. All the onboard units 105a-c transmit diagnostic data via a communication link 110b to a diagnostic data interface 115b of the cloud environment 300. The communication links 110a, b can be designed as multiple parallel links for the purpose of load balancing. Because only the train that corresponds to the onboard unit 105a is the one that is currently driven, it is necessary that this onboard unit 105a transmits video data. However, it is also possible that all onboard units 105a-c transmit video data to the video data interface 115a in parallel. The communication links 110a, b are mobile communication links. Internal communication links 120a, b are provided within the cloud environment 300 to facilitate a data exchange between a streaming service 125 and the video data interface 115a and between the diagnostic data interface 115b and a diagnostic dashboard 130.

The cloud environment 300 also comprises three configuration modules 135a-c, wherein only the configuration module 135a will be described in the following as it corresponds to the onboard unit 105a. It can be extended to an arbitrary number of configuration modules.

The configuration modules 135 that can be run on a computing unit comprise a driving-control-converting-algorithm that takes configurations of the train equipped with the onboard unit 105a into account to generate a vehicle-specific-2D-model, a vehicle-specific-model or a virtual-reality-model based on characteristic configurations of the train 140a, wherein the models show control elements and/or status elements of the train abstracted way. The creation of the vehicle-specific-2D-model, the vehicle-specific-model or a virtual-reality-model can also take characteristics of a certain workspace 141a and a desired driver set up 142a into account.

The model can be handed over to a control adaption module 145 and interact with a control dashboard module 150, wherein both of these modules configure the model in a way that the operator can interact with it. The control adaption module 145 and the control dashboard module 150 can generate the driving commands due to the remote driving interactions of the operator. For that purpose, a second communication link 160 is provided between the control dashboard 150 a first touchscreen 215a and a n-th touchscreen 215n of a control module 210 of a remote operator workplace. Instead of the touchscreens 215 or additional to the touchscreens 215, other operating interface(s) like a computer mouse, joystick and/or keyboard can be used to generate the driving commands. It is possible that the generated driving commands are sent back over the second communication link 160 and then forwarded by the cloud environment 300 to the onboard unit 105 or that the remote operator workplace 200 directly sends the driving commands to the onboard unit 105 via a mobile communication network. The following distinction is possible: Option a) Data goes directly to the display, then the displays need own software (usually touch displays in trains with own processor and operating systems like Linux or similar); Option b) Data goes to desktop PC 250, which generates the visualization for the display according to the configurations of the model, the displays themselves are then just “dumb” display and input elements (in case of touch screens).

The model can be filled with video data and diagnostic data, so that a real-time-vehicle-specific-model results 190. The driving commands can also be generated by considering the real-time-vehicle-specific-model results. The real-time-vehicle-specific-model 190 can be displayed to the operator on the remote operator workspace 200 in two different parts to increase the clarity of the presentation. A desktop PC 250 with one or more screens of the remote operator workspace 200 can be used for this task. One part is the already described control module 210, wherein the other part is a supervision module 230. Those supervision module 230 receives the video stream 180 and diagnostic data 185 over communication links and displays them on monitors 235a-c and/or touchscreens 235a-c.

The supervision module 230 can optionally pick up concepts of the EUDDplus (European Driver's Desk plus) with extensions. This includes 4 displays with display and input possibilities with the following scope: Train Radio Display; Electronic Time-table Display; Control Command Display; Technical and Diagnostic Display; EVU-Specific Display (optional).

According to the driving circumstances, the operator observes the monitors 235a-c and/or touchscreens 235a-c and performs appropriate driving commands by interaction with the control module 210. Optionally, the control module 210 can also comprise continues traction/brake lever 220a, an EB button 220b and/or a Driver Vigilance Device e.g. integrated within traction and braking lever 220c.

As an advantageous effect, the remote driving control system 100 provides supervision monitors 235a-c and/or touchscreens 235a-c that allows supervision of the vehicle at arbitrary workplaces 200. That dashboard is independent of the workplace design, its hardware representation and allows also to break up the 1-to-1 relation into a 1-to-n relation for supervision task.

The supervision dashboard(s) includes video streaming for observation of vehicle surrounding (e.g. including pantograph on trains or propellers of ships), the path of travel (e.g. including obstacle detection and highlighting), and the inside of the vehicle (e.g. engine room and driver desk). Moreover, for supervision also diagnostic information can be shown if provided by the vehicle.

While state-of-the-art solution allows to connect only one specific vehicle to only a single remote operator workplace at a time, the new design allows to spread that dashboard to an arbitrary number of users/systems in real time.

The invention allows to configure the supervision dashboard(s) based on vehicle characteristics, remote operator workplace capabilities, and remote operator preferences. For each vehicle type it can be configured once which video signals are available, which control elements are available and mandatorily to be used. Based on this one-time configuration more or less few video streams can be made available. Also based on that configuration the control elements required for operating the vehicle/train can be enabled or disable. This includes also a potential rearrangement of control elements and video streams shown to the remote operator in order to achieve the best usability. Examples may include door control that is required for passenger trains but not for freight train.

The invention decouples the design of the workplace 200 from vehicle's characteristics and driver's preferences. The visualization of control and supervision dashboards can also be configured according to driver's preferences, e.g. the driver wants to operate with or without audio signals from the train. Also, the dashboards can be configured according to the workplace characteristics, i.e. the amount and types of displays for visualization and control of the dashboards.

The visualization can be realized as browser based dashboards that allows visualization on any kind of hardware, even tablets and smartphones.

The control dashboards can either be operated through mouse/keyboard/joystick interactions or through touch-displays.

This design allows to capture log data directly from the vehicle and can provide direct access to diagnostic data storage for data analytics with arbitrary purpose. The availability of diagnostic data is not restricted to a specific workplace that is connected to the vehicle.

The remote driving control system 100 provides control dashboard(s) that allows to remotely control the vehicle movement, preconditioned safety of travel is ensured. That dashboard presentation 215a-n and 235a-c of the remote operator workplace 200 is independent of the workplace design and its hardware representation, and it is as independent as possible from vehicle's characteristics. This decoupling is achieved through abstraction within i) the control dashboard 150 where only generic control elements are available and though ii) the control adaptation module 145 which adapts the generic control commands back to the vehicle/train specifics. The return transmission from the control adaptation module 145 to the vehicle can pass through the same channels as the transmission from the vehicle to the control adaptation module 145. Instead of using a specific control interface that matches to the vehicle's characteristics, e.g. number and style of control elements, the control dashboard of the control module 210 provide a generic control interface applicable for all types of vehicles and trains. A cloud service for vehicle control can adapt the control commands control adaptation module 145 to the vehicle specifics.

One example is the control of brake systems: in freight trains three different brake systems are controlled individually (electrodynamic brake of locomotive, pneumatic brake of locomotive, pneumatic brake of train). In other types of passenger trains and also metros or trams the brake is operated by a single control handle and the brake force split is done by the vehicle control system. The “control adaptation” of our proposed system can introduce the abstraction layer and provide a single brake control handle for all train types, including freight trains. Nevertheless, it is still possible to configure the control dashboard such that the remote operator, if sufficiently skilled, can still operate all brake systems individually by his own and the control adaption is not needed. This will depend on national/company rules and driver qualification and preferences.

Possible functions of the control adaption module 145 might cover the following functionalities:
a) the split of requested brake force or deceleration rates onto different brake systems;
b) the limitation of set values commanded by the remote operator;
c) the limitation of slopes for increasing/decreasing requested traction/brake forces or acceleration/deceleration;
d) specific handling of braking and/or traction commands while starting/stretching of the train or for stopping the train;
e) minimum time delay for traction after brake release;
f) specific handling of braking and/or traction commands while driving over points;
g) other functions.

The functionalities are applied to the cloud service for control according to national/organizational/technical rules and taking into account railway vehicle or train capabilities. These characteristics are provided as configuration to the cloud service for control and decouple the workplace design from vehicle's characteristics.

Additionally, it is also possible to configure the control dashboard(s) according to driver preferences (within regulatory restrictions given by national/organizational/technical rules) In addition to the control adaptation 145, it is possible to reuse available knowledge on vehicle/train characteristics to identify deviations and to write this information in a database that stores default configuration data and/or real-time configuration data of the specific vehicle. For example, even if the vehicle/train has a specific available traction force the resulting acceleration can be much slower, which can be caused by insufficient information on track gradients, false information on the vehicle's/train's mass (including load) or which can also be caused by errors in the traction system. Hence, that information can be used for incident detection, abnormality detection, and/or predictive maintenance.

Moreover, a defined procedure can also be used to adjust the control adaptation 145 and relevant configuration. If as in the previous example, the mass of a freight train or the load of a passenger train is not sufficiently accurate, then based on learning from abnormality detection (deviation between expectation and observation) the train's mass can be corrected for the usage in control adaptation 145 to achieve better controllability.

In case the remote operator switches between supervision and control for different vehicle/train types, awareness of the remote operator for the differences shall be ensured by the cloud service. This can be realized via a short introduction for the remote operator to the available dashboard elements, e.g. types of control handles. This can be similar to computer games as interactive quick start guide or tutorial in which players are introduced to the player/gamer interface, when they start the game.

In addition to the information that is available on-board of the train and can be displayed on the dashboard(s) for the remote operator, it is possible to provide further information that can support the driver in execution of his driving task. While on-board train drivers require explicit knowledge and training for specific tracks/routes that might not always be possible or necessary for remote operators. For compensating this lack of knowledge it is possible to show the track characteristics in advance to support driving to the train operator. This can comprise information like the upcoming gradient profile, track curvature, speed profile and information about tunnel, bridges, points, and others. A graphical representation of this information can be used, e.g. on maps or as straight line topology, to improve usability for the remote operator.

Moreover, information can be provided to the train operator that is not available to on-board train driver. This can comprise information like the occurrence of slip/slide in specific track segments as reported by preceding trains on that segment, e.g. through Subset-126 status report. That example will help the remote operator to brake earlier, therefore reducing the required deceleration rate, and avoiding to overshoot the target speed restriction or a stopping point.

All dashboards are configured to be operated via keyboard, mouse, and/or touch displays and do not require (vehicle) specific realization of the remote operator workplace.

Additional physical control handles for specific but vehicle agnostic commands are possible but not mandatory, e.g. for driver vigilance device, emergency button, traction/brake lever.

The cloud service shall comply with the required regulations for safety and security.

The remote driving control system can be located in a cloud environment, e.g. a public or private cloud, or any other kind of public/private data center.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for enabling remote driving control of railway vehicles, ship vehicles, drones, and/or farm vehicles via a generic workspace, the method comprising:
using, by a remote driving control system, a driving-control-converting-algorithm, wherein the driving-control-converting-algorithm transforms control elements and/or status elements of a vehicle into a vehicle-specific model;
providing, by the remote driving control system, the vehicle-specific model with data received from a vehicle operation onboard unit and/or a remote control onboard unit of the vehicle as input data, wherein the vehicle-specific model is configured to recognize the data and pass it to respective abstracted control elements and/or status elements which results in a real-time-vehicle-specific model; and
displaying, by the remote driving control system, the real-time-vehicle-specific model on a remote operator workspace wherein the vehicle is driven based on a remote operator interacting with the real-time-vehicle-specific model via operating element(s) of the remote operator workspace.

2. The method of claim 1, wherein the driving-control-converting-algorithm has access to and uses a database that stores default configuration data and/or real-time configuration data of the vehicle.

3. The method of claim 2, wherein the real-time configuration data comprises sensor data of the vehicle, sensor data of another vehicle, sensor data of track sensors, and/or timetable data.

4. The method of claim 1, wherein at least two real-time-vehicle-specific model are displayed on a screen or on a virtual glasses of the workspace.

5. The method of claim 4, wherein the real-time-vehicle-specific-model that corresponds to the vehicle the remote operator is currently driving is displayed in a highlighted mode.

6. The method of claim 5, wherein the highlighted mode shows the current real-time-vehicle-specific model with a bigger size and/or with a higher data rate than another non-current real-time-vehicle-specific model.

7. The method of claim 1, wherein a pop-up window with vehicle-specific information appears based on the remote operator switching between different real-time-vehicle-specific models; and/or
wherein a pop-up window with emergency information appears based on an emergency being detected by the vehicle or by track sensors.

8. The method of claim 1, wherein an illustration of the vehicle is displayed in a virtual environment and/or within captured video data of the vehicle, wherein the illustration also shows steering angle and braking predictions as lines, and wherein the predictions are based on usage of the operating element(s) by the remote operator and the real-time-vehicle-specific model.

9. The method of claim 1, wherein the operating element(s) comprise a computer mouse, touchscreen, a keyboard, and/or a joystick.

10. The method of claim 9, wherein the joystick comprises force feedback elements, wherein force feedback is adjusted according to the vehicle that is currently under operation.

11. The method of claim 1, wherein the remote operator workspace comprises virtual glasses, a desktop computer, a smartphone, and/or a tablet.

12. The method of claim 1, wherein an appearance of the real-time-vehicle-specific model is adjustable by the remote operator; and/or
wherein an appearance of the real-time-vehicle-specific model takes characteristics of the workspace into account.

13. The method of claim 1, wherein the driving-control converting algorithm and/or the real-time-vehicle-specific model are implemented on a cloud server in a cloud environment

14. A remote driving control system for enabling remote driving control of railway vehicles, ship vehicles, drones, and/or farm vehicles via a generic workspace, the system comprising
a server configured to:
receive data captured by a vehicle and to send driving commands of a remote operator to the vehicle;
use a driving-control-converting-algorithm to abstract control elements of the vehicle into a vehicle-specific-model; and
provide the vehicle-specific-model with the data received from the vehicle as input data, wherein the vehicle-specific-model is configured to recognize the data and pass the data to respective abstracted control elements and/or status elements and to generate a real-time-vehicle-specific model
a display configured to display the real-time-vehicle-specific-model to the remote operator; and
operating element(s) configured to enable an interaction of the remote operator with the real-time-vehicle-specific model wherein the real-time-vehicle-specific model is configured to generate driving commands based on the interaction.

15. A non-transitory computer-readable medium having instructions stored thereon for enabling remote driving control of railway vehicles, ship vehicles, drones, and/or farm vehicles via a generic workspace. wherein the instructions, when executed facilitate performance of the following:
using, by a remote driving control system, a driving-control-converting-algorithm. wherein the driving-control-converting-algorithm transforms control elements and/or status elements of a vehicle into a vehicle-specific model;
providing, by the remote driving control system, the vehicle-specific model with data received from a vehicle operation onboard unit and/or a remote control onboard unit of the vehicle as input data, wherein the vehicle-specific model is configured to recognize the data and pass it to respective abstracted control elements and/or status elements which results in a real-time-vehicle-specific model; and
displaying, by the remote driving control system, the real-time-vehicle-specific model on a remote operator workspace, wherein the vehicle is driven based on a remote operator interacting with the real-time-vehicle-specific model via operating element(s) of the remote operator workspace.
